(19) United States
(12) Patent Application Publication
(10) Pub. No.: US 2025/0385326 A1
(43) Pub. Date: Dec. 18, 2025

(54) BATTERY WITH SELECTIVELY LOCATED COMPONENTRY OF A BATTERY MANAGEMENT UNIT

(71) Applicant: Apple Inc., Cupertino, CA (US)

(72) Inventors: Abhishek P Shiwalkar, Scotts Valley, CA (US); Hirotsugu Oba, Sunnyvale, CA (US); Christopher R Pasma, Redwood City, CA (US)

(21) Appl. No.: 18/743,873

(22) Filed: Jun. 14, 2024

(51) Int. Cl. H01M 10/42; H01M 50/103; H01M 50/169; H01M 50/176; H01M 50/202

(52) U.S. Cl. CPC H01M 10/4257; H01M 50/103; H01M 50/169; H01M 50/176; H01M 50/202; H01M 2010/4271

(57) ABSTRACT

A battery includes an enclosure having a longitudinal body section and a lateral body section extending from and normal to the longitudinal body section, where an intersection of the longitudinal body section and the lateral body section defines an interior corner. The battery also includes electrodes disposed within the enclosure. The battery also includes a battery management unit (BMU), where at least a portion of the BMU is disposed external to the enclosure and adjacent to the interior corner.

### BACKGROUND

The present disclosure relates generally to batteries, such as secondary or rechargeable batteries (e.g., lithium-ion batteries, lithium iron phosphate batteries, lithium-ion polymer batteries, nickel-cadmium batteries, nickel-metal hydride batteries, lead-acid batteries, etc.), configured to power a load. More specifically, the present disclosure relates to spatial arrangements of a battery management unit (BMU) of a battery, or portions thereof, relative to a battery enclosure of the battery and/or a battery receptacle in a load enclosure of the load.

Batteries such as those described above may be employed in a variety of applications, such as a consumer electronic or other type of load. For example, a battery may be electrically coupled to one or more aspects of the load and disposed in an area of the load (e.g., a battery receptacle in a load enclosure of the load) configured to receive the battery. Unfortunately, traditional configurations may include spatial arrangements of the battery, or portions thereof, that are not adequately tailored to the area in the load configured to receive the battery, resulting in wasted space within the load (e.g., consumer electronic). Additionally or alternatively, traditional spatial arrangements may negatively affect a capacity and/or volumetric energy density of the battery. Accordingly, it is now recognized that there is a need for improved batteries and spatial arrangements thereof.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a battery includes an enclosure having a longitudinal body section and a lateral body section extending from and normal to the longitudinal body section, where an intersection of the longitudinal body section and the lateral body section defines an interior corner. The battery also includes electrodes disposed within the enclosure. The battery also includes a battery management unit (BMU), where at least a portion of the BMU is disposed external to the enclosure and adjacent to the interior corner.

In another embodiment, a battery includes an enclosure including a first portion and a second portion extending transverse to the first portion, where an intersection of the first portion and the second portion defines an interior corner. The battery also includes electrodes forming a stacked arrangement within the enclosure. The battery also includes a battery management unit (BMU), where at least a portion of the BMU is disposed external to the enclosure and extends adjacent to the interior corner.

In another embodiment, a consumer electronic device includes a device enclosure, a boundary defined within the device enclosure, and a battery. The battery includes battery enclosure configured to be disposed within the boundary, where the battery enclosure includes a first leg section and a second leg section extending from and normal to the first leg section such that an intersection between the first leg section and the second leg section defines an interior notch region. The consumer electronic device also includes a cavity adjacent to the interior notch region and between the battery enclosure and the boundary. The battery includes a battery management unit (BMU), where at least a portion of the BMU is disposed external to the battery enclosure and extends into the cavity.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a block diagram of a battery configured to power a load, such as the electronic device of FIG. 1, where the battery includes componentry, such as a battery management unit (BMU) or portion thereof, selectively located relative to a battery enclosure of the battery and/or a battery area (e.g., battery receptacle) defined in or by the load, according to embodiments of the present disclosure;

FIG. 3 is a cross-sectional front view of the battery of FIG. 2 disposed within the battery area (e.g., battery receptacle) of the load, where a chip board, a weld pad, a flex circuit, and at least a portion of an electrical feedthrough of the BMU are selectively located along an exterior of the battery enclosure and adjacent to an interior corner defined by the battery enclosure, according to embodiments of the present disclosure;

FIG. 4 is a front view of the battery of FIG. 2 disposed within the area (e.g., battery receptacle) of the load, where a chip board, a weld pad, a flex circuit, and at least a portion of an electrical feedthrough of the BMU are selectively located along an exterior of the battery enclosure and adjacent to an interior corner defined by the battery enclosure, according to embodiments of the present disclosure;

FIG. 5 is a front view of the battery of FIG. 2 disposed within the area (e.g., battery receptacle) of the load, where a chip board, a flex circuit, and a weld pad of the BMU are selectively located along an exterior of the battery enclosure and adjacent to an interior corner defined by the battery enclosure, according to embodiments of the present disclosure;

FIG. 6 is a front view of the battery of FIG. 2 disposed within the area (e.g., battery receptacle) of the load, where a chip board, a flex circuit, and a weld pad of the BMU are selectively located along an exterior of the battery enclosure and adjacent to an interior corner defined by the battery enclosure, and a thickness of the chip board extends substantially parallel to a thickness of the battery enclosure, according to embodiments of the present disclosure;

FIG. 7 is a back view of the battery of FIG. 2, where the battery enclosure includes an enclosure body and a cover coupled (e.g., seam welded) to a portion (e.g., a flange) of the enclosure body, according to embodiments of the present disclosure;

FIG. 8 is a cross-sectional view of a portion of the battery of FIG. 7, taken along line 8-8 in FIG. 7, according to embodiments of the present disclosure; and

FIG. 9 is a process flow diagram illustrating a method of assembling a battery, such as the battery of FIG. 2, and integrating the battery with a load, such as the electronic device of FIG. 1, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

This disclosure is directed to batteries, such as secondary or rechargeable batteries (e.g., lithium-ion batteries, lithium iron phosphate batteries, lithium-ion polymer batteries, nickel-cadmium batteries, nickel-metal hydride batteries, lead-acid batteries, etc.), employed in a variety of applications, such as a consumer electronic. More specifically, the present disclosure is directed to spatial arrangements of a battery management unit (BMU) of a battery, or portions thereof, relative to an enclosure of the battery, such as one or more locations along an exterior of an enclosure of the battery.

A consumer electronic may include an enclosure in which componentry of the consumer electronic, including a battery, is disposed. For example, the battery may be disposed in a battery receptacle in the enclosure configured to receive the battery. In some embodiments, the battery receptacle includes a shape and/or size similar to a shape and/or size of a battery enclosure of the battery. However, the shape and/or size of the battery enclosure and the shape and/or size of the battery receptacle, while similar, may not be identical.

As an example, a footprint (e.g., generally L-shaped footprint, 2-D cross-sectional footprint) of the battery enclosure may include a longitudinal body section, a lateral body section extending from and normal to the longitudinal body section, and an intersection between the longitudinal body section and the lateral body section defining an interior corner, where the interior corner includes a curved surface (e.g., an arcuate surface, a semi-circle surface, etc.). The curved surface is referred to in certain instances of the present disclosure as a notch or a notch region (e.g., interior notch or interior notch region) of the battery enclosure. In contrast, an additional footprint (e.g., additional generally L-shaped footprint, additional 2-D cross-sectional footprint) of the battery receptacle may include an additional longitudinal body section, an additional lateral body section extending from and normal to the additional longitudinal body section, and an additional intersection between the additional body section and the additional lateral body section defining an additional interior corner, where the additional interior corner forms, for example, a right angle. Accordingly, after receiving the battery, the battery receptacle may include a space (e.g., cavity) between the interior corner of the battery enclosure and the interior corner of the battery receptacle. That is, the space (e.g., cavity) may be aligned with the notch or notch region of the battery enclosure. Presently disclosed embodiments include a battery management unit (BMU) of the battery having certain componentry (e.g., a chip board, a weld pad, an electrical feedthrough or portion thereof, a flex circuit, etc.) disposed along an exterior of the battery enclosure and extending within in the space.

As described in greater detail with reference to the drawings, locating componentry of the BMU of the battery in the space described above (e.g., along the exterior of the battery enclosure and adjacent to the notch or notch region) may reduce wasted space in the consumer electronic, improve a capacity and/or volumetric energy density of the battery, or both, among other possible technical benefits. These and other aspects of the present disclosure are described below with reference to the drawings.

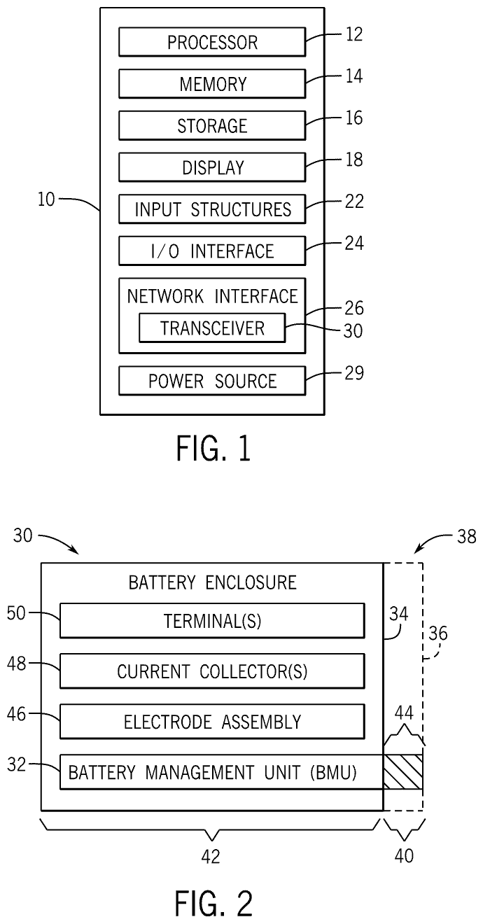

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power source 29 of the electronic device 10 may include any suitable source of power, such as a rechargeable lithium polymer (Li-poly) battery and/or an alternating current (AC) power converter. In accordance with embodiments of the present disclosure, the power source 29 may include a battery enclosure disposed within a battery receptacle of the electronic device 10. While a shape and/or size of a battery enclosure of the battery and a shape and/or size of the battery receptacle may be similar, differences therebetween may result, in traditional configurations, in an otherwise unused space in the battery receptacle. Accordingly, presently disclosed embodiments include a battery management unit (BMU) of the battery having at least some componentry disposed in the otherwise unused space in the battery receptacle. These and other aspects of the present disclosure are described in detail below with reference to later drawings.

FIG. 2 is a block diagram of an embodiment of a battery 30 configured to power a load, such as the electronic device 10 of FIG. 1, where the battery 30 includes componentry, such as a portion of a battery management unit (BMU) 32, selectively located relative to a battery enclosure 34 of the battery 30 and/or within a portion of a battery area 36 (e.g., battery receptacle, battery boundary) defined in the load. The battery area 36 (e.g., battery receptacle) may be defined in a load enclosure, referred to below as a device enclosure 38, of the load.

In the illustrated embodiment, the battery area 36 (e.g., battery receptacle, battery boundary) defined in the device enclosure 38 includes a size and/or shape that is similar, but not identical, to a size and/or shape of the battery enclosure 34 of the battery 30. For example, a portion 40 of the battery area 36 may extend beyond the battery enclosure 34 of the battery 30, as shown. In accordance with present embodiments, componentry of the battery 30 is configured to be disposed along an exterior of the battery enclosure 34 and within the portion 40 of the battery area 36. In this way, at least some of the portion 40 of the battery area 36 of the device enclosure 38 is not wasted.

For example, while a first portion 42 of the BMU 32 may reside within the battery enclosure 34 in the illustrated embodiment, a second portion 44 of the BMU 32 may be disposed outside of the battery enclosure 34, along an exterior of the battery enclosure 34, and within the portion 40 of the battery area 36 in the device enclosure 38. In other embodiments, an entirety of the BMU 32 may be disposed outside of the battery enclosure 34, along an exterior of the battery enclosure 34, and within the portion 40 of the battery area 36 in the device enclosure 38. Sizes of the first portion 42 and the second portion 44 illustrated in FIG. 2 should not be taken as necessarily implying that the first portion 42 is larger, or includes more componentry, than the second portion 44. As described in greater detail with reference to later drawings, in some embodiments, the second portion 44 of the BMU 32 disposed outside of the battery enclosure 34, along an exterior of the battery enclosure 34, and within the portion 40 of the battery area 36 in the device enclosure 38 may include, for example, a chip board (e.g., having processing circuitry and/or memory circuitry thereon), a flex circuit, a weld pad, an electrical feedthrough, or portions thereof, or any combination thereof, among other possible componentry.

Other componentry of the battery 30 in FIG. 2 includes an electrode assembly 46 having two or more electrodes and one or more separators, one or more current collectors 48 coupled to the electrode assembly 46, and one or more terminals 50 (e.g., electrode terminal tabs). In some embodiments, the one or more terminals 50 (or a portion thereof) extends outside of the battery enclosure 34 for exposure to electrical connections between the battery 30 and aspects of the load (e.g., the electronic device 10 in FIG. 1). Further, electrolyte may be disposed in the battery enclosure 34 to facilitate ionic movement between electrodes of the electrode assembly 46, enabling charge and discharge of the battery 30. In general, the BMU 32 is configured to monitor operational aspects (e.g., a temperature, a state-of-charge or SOC, etc.) of the battery 30, regulate operational aspects of the battery 30, and/or transmit or receive communications (e.g., to or from the load), among other possible functions.

By disposing at least the second portion 44 of the BMU 32 outside of the battery enclosure 34, along the exterior of the battery enclosure 34, and within the portion 40 of the battery area 36 (e.g., battery receptacle, battery boundary) in the device enclosure 38, at least some of the portion 40 of the battery area 36 is not wasted, unlike certain traditional configurations. Further, by moving the second portion 44 of the BMU 32 outside of the battery enclosure 34, space within the battery enclosure 34 typically reserved for the BMU 32 (e.g., the second portion 44 of the BMU 32) may be used for other componentry, such as larger electrodes of the electrode assembly 46, which may contribute to improved capacity and/or volumetric energy density of the battery 30 relative to traditional configurations. These and other aspects of the present disclosure are described in detail below with reference to later drawings.

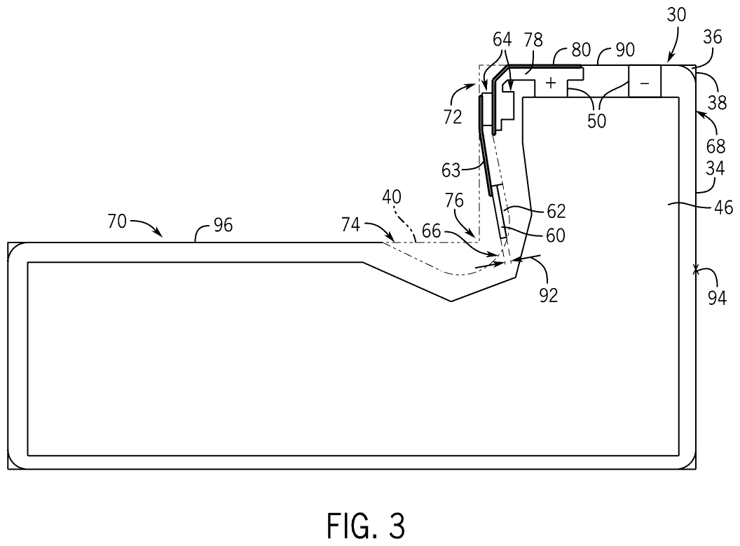

FIG. 3 is a cross-sectional front view of an embodiment of the battery 30 of FIG. 2 disposed within the battery area 36 (e.g., battery receptacle, battery boundary) defined by the device enclosure 38, where a chip board 60, a weld pad 62, a flex circuit 63, and at least a portion of an electrical feedthrough 64 (e.g., of the BMU 32 in FIG. 2) are selectively located along an exterior of the battery enclosure 34 and adjacent to an interior corner 66 defined by the battery enclosure 34. In the illustrated embodiment, the battery enclosure 34 includes a first portion, referred to below as a longitudinal body section 68, and a second portion, referred to below as a lateral body section 70. The longitudinal body section 68 may extend transverse and normal to the lateral body section 70, as shown. Further, an intersection between the longitudinal body section 68 and the lateral body section 70 defines the interior corner 66. The longitudinal body section 68, the lateral body section 70, and the interior corner 66 defined by the intersection therebetween may form a generally L-shaped footprint (e.g., cross-sectional footprint).

As shown, the interior corner 66 may include a curved and/or sloped surface, referred to in certain instances of the present disclosure as a notch or a notch region (e.g., interior notch or interior notch region) of the battery enclosure 34. In accordance with present embodiments, componentry of the battery 30, such as componentry of the BMU 32 in FIG. 2, may be disposed adjacent to the notch or notch region of the battery enclosure 34 and along an exterior of the battery enclosure 34. Additionally or alternatively, such componentry (e.g., the chip board 60, the weld pad 62, the flex circuit 63, a portion of the electrical feedthrough 64, etc.) may be disposed in the portion 40 of the battery area 36 (e.g., battery receptacle, battery boundary) defined by the device enclosure 38 that would otherwise be unused in certain traditional configurations.

For example, the battery area 36 defined in the device enclosure 38 may include an additional longitudinal body section 72 at least partially aligned in space with the longitudinal body section 68 of the battery enclosure 34, and an additional lateral body section 74 at least partially aligned in space with the lateral body section 70 of the battery enclosure 34, where the additional longitudinal body section 72 may extend transverse and normal to the additional lateral body section 74. The additional longitudinal body section 72 and the additional lateral body section 74 of the battery area 36 defined by the device enclosure 38 may intersect to define an additional interior corner 76. The additional longitudinal body section 72, the additional lateral body section 74, and the additional interior corner 76 defined by the intersection therebetween may form an additional generally L-shaped footprint (e.g., cross-sectional footprint).

Unlike the interior corner 66 of the battery enclosure 34, which includes a sloped and/or curved surface as previously described, the additional interior corner 76 of the battery area 36 defined by the device enclosure 38 may form a right angle or some other shape that does not align with the sloped and/or curved surface of the interior corner 66 of the battery enclosure 34. For these and other possible reasons, the portion 40 of the battery area 36 defined by the device enclosure 38 may not receive the battery enclosure 34. The portion 40 may instead receive, for example, the chip board 60, the weld pad 62, the flex circuit 63, and at least a portion of the electrical feedthrough 64. That is, the chip board 60, the weld pad 62, the flex circuit 63, and at least a portion of the electrical feedthrough 64 in FIG. 3 may correspond to the second portion 44 of the BMU 32 illustrated in (and described above with respect to) FIG. 2.

The chip board 60 may include, for example, processing circuitry and/or memory circuitry employed to monitor operational aspects of the battery 30, regulate operational aspects of the battery 30, communicate data to or from the load or other locations, and/or perform other possible functions. The weld pad 62 may be employed to adhere the chip board 60 to the battery enclosure 34, such as an exterior (e.g., external surface) of the battery enclosure 34. The electrical feedthrough 64 may be employed to enable an electrical connection between the chip board 60 located outside of the battery enclosure 34 and one of the terminals 50 (e.g., electrode terminal tabs) located at least partially within the battery enclosure 34. For example, the electrical feedthrough 64 may extend from an interior of the battery enclosure 34, through an opening in the battery enclosure 34, and to an exterior of the battery enclosure 34. An electrical connection 78 may extend between one of the terminals 50 and an internal portion of the electrical feedthrough 64, and the flex circuit 63 may extend from an external portion of the electrical feedthrough 64 to the chip board 60. An insulator 80 may be used to insulate the electrical connection 78, the internal portion of the electrical feedthrough 64, or both from electrically conductive materials, such as the battery enclosure 34, in an effort to prevent short circuits.

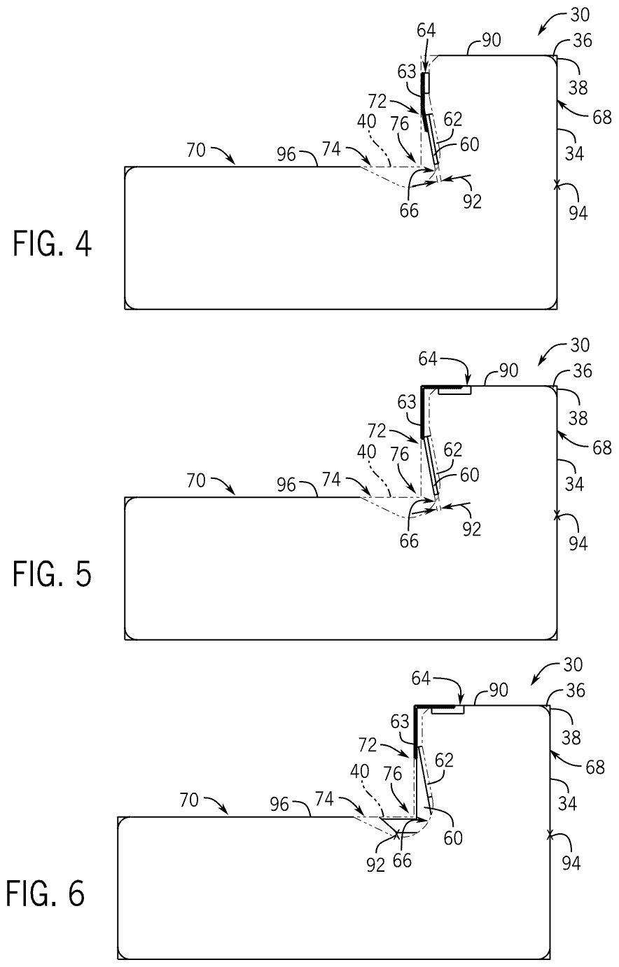

FIG. 4 is a front view of an embodiment of the battery 30 of FIG. 2 disposed within the battery area 36 (e.g., battery receptacle, battery boundary) defined by the device enclosure 38. FIG. 4 is substantially similar to FIG. 3, except that FIG. 3 illustrates a cross-sectional front view of the battery 30. FIG. 5 is a front view of an embodiment of the battery 30 of FIG. 2 disposed within the battery area 36 defined by the device enclosure 38, where the chip board 60 and the weld pad 62 (e.g., of the BMU 32 in FIG. 2) are selectively located along the exterior of the battery enclosure 34 and adjacent to an interior corner 66 defined by the battery enclosure 34. Unlike in FIGS. 3 and 4, in FIG. 5, the electrical feedthrough 64 is not disposed adjacent to the interior corner 66 defined by the battery enclosure 34. Indeed, in FIG. 5, the electrical feedthrough 64 is disposed at or adjacent to a top 90 of the longitudinal body section 68 of the battery enclosure 34. That is, the electrical feedthrough 64 may be disposed at or adjacent to a first edge of the longitudinal body section 68 of the battery enclosure 34 that is normal or orthogonal to a second edge of the longitudinal body section 68 of the battery enclosure 34, which in turn is disposed at or adjacent to the top 90 of the longitudinal body section 68 of the battery enclosure 34. FIG. 6 is a front view of an embodiment of the battery 30 of FIG. 2 disposed within the battery area 36 defined by the device enclosure 38, where the electrical feedthrough 64 in FIG. 6 is disposed at the top 90 of the longitudinal body section 68 of the battery enclosure 34, similar to FIG. 5.

An orientation of the chip board 60 in FIG. 6 differs from an orientation of the chip board 60 in FIGS. 3-5. For example, in FIGS. 3-5, a thickness 92 of the chip board 60 extends transverse (e.g., perpendicular) to a thickness 94 of the battery enclosure 34. That is, a plane of the thickness 92 of the chip board 60 may intersect a plane of the thickness 94 of the battery enclosure 34. In FIG. 6, the thickness 92 of the chip board 60 extends parallel to the thickness 94 of the battery enclosure 34. That is, a plane of the thickness 92 of the chip board 60 may be parallel with or be coextensive with a plane of the thickness 94 of the battery enclosure 34. It should be noted that the thickness 92 (or width) of the chip board 60 may correspond to a smallest side of the chip board 60 (e.g., smaller than a length and a height of the chip board 60), and the thickness 94 (or width) of the battery enclosure 34 may correspond to a smallest side of the battery enclosure 34 (e.g., smaller than a length and a height of the battery enclosure 34). Other possible configurations and/or orientations of the chip board 60, the weld pad 62, the flex circuit 63, the electrical feedthrough 64, etc. are also possible in accordance with the present disclosure.

As previously described with respect to FIGS. 2-6, portions of the BMU 32 of FIG. 2, such as any one or combination of the chip board 60, the weld pad 62, the flex circuit 63, and the electrical feedthrough 64 (or external portion thereof), may be disposed along an exterior of the battery enclosure 34, within the portion 40 of the battery area 36 defined by the device enclosure 38 that does not receive the battery enclosure 34, and adjacent to the interior corner 66 defined by the intersection between the longitudinal body section 68 and the lateral body section 70 of the battery enclosure 34. As used here, “adjacent to” the interior corner 66 may refer to any location (e.g., along the exterior of the battery enclosure 34 and within the portion 40 of the battery area 36 defined by the device enclosure 38) residing between the top 90 of the longitudinal body section 68 of the battery enclosure 34 and a flat segment 96 of the lateral body section 70 of the battery enclosure 34. In other words, any location within the portion 40 of the battery area 36 defined by the device enclosure 38 and not receiving the battery enclosure 34 may be “adjacent to” the interior corner 66 of the battery enclosure 34.

As previously described, the area along the exterior of the battery enclosure 34 receiving aspects of the BMU 32 in FIG. 2 may be referred to as a notch or notch region (e.g., interior notch or interior notch region). By locating componentry of the BMU 32 in, at, or adjacent to the notch or notch region as described above, the portion 40 of the battery area 36 defined by the device enclosure 38 that does not receive the battery enclosure 34 is not wasted, since componentry of, for example, the BMU 32 is located in the portion 40 of the battery area 36. Further, by moving such componentry of the BMU 32 from within the battery enclosure 34 to the exterior of the battery enclosure 34, a size of the battery enclosure 34 may be reduced and/or a size of other componentry within the battery enclosure 34, such as the electrode assembly 46 illustrated in FIGS. 2 and 3, can be increased, thereby improving a capacity and/or volumetric energy density of the battery 30.

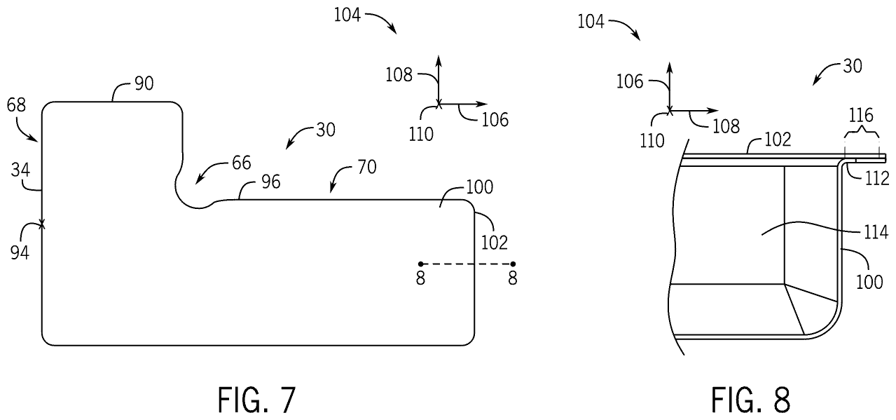

FIG. 7 is a back view of an embodiment of the battery 30 of FIG. 2, where the battery enclosure 34 includes an enclosure body 100 and a cover 102 coupled (e.g., seam welded) to a portion of the enclosure body 100. Certain reference numerals and corresponding features described above with respect to FIGS. 2-6 are illustrated in FIG. 7. FIG. 8 is a cross-sectional view of a portion of the battery 30 of FIG. 7, taken along line 8-8 in FIG. 7. A coordinate system 104 (e.g., including a first axis 106, a second axis 108, and a third axis 110) is illustrated in FIGS. 7 and 8 to clarify an orientation of various features of the battery 30 across FIGS. 7 and 8. As illustrated in FIG. 8, a flange 112 of the enclosure body 100 is coupled to the cover 102, which seals a cavity 114 between the enclosure body 100 and the cover 102. For example a seam weld 116 may be employed to couple the enclosure body 100 to the cover 102. As shown in FIG. 7, the cover 102 may extend along an entirety or a majority of a boundary of the battery enclosure 34 of the battery 30. Features illustrated in FIGS. 7 and 8 and described above may enable mounting of componentry to the exterior of the battery enclosure 34 (e.g., to the cover 102) and/or otherwise improve an ability to dispose componentry in the aforementioned locations along the exterior of the battery enclosure 34 while remaining within, for example, the battery area 36 illustrated in FIGS. 2-6.

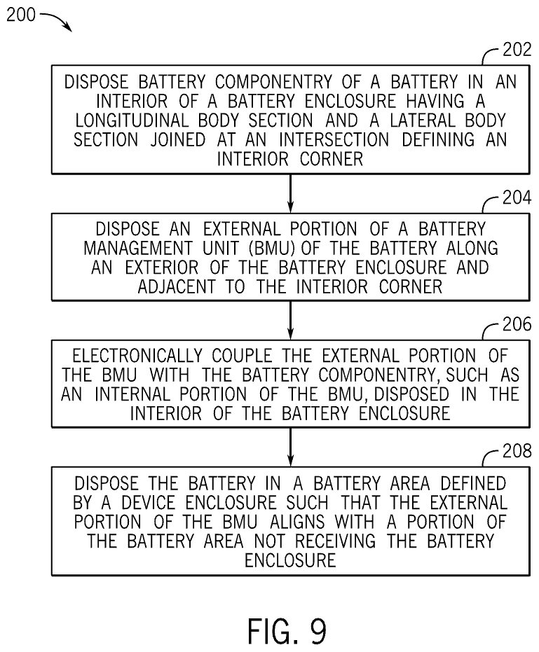

FIG. 9 is a process flow diagram illustrating an embodiment of a method 200 of assembling a battery, such as the battery 30 of FIG. 2, and integrating the battery with a load, such as the electronic device 10 of FIG. 1. An order or chronology of the steps (e.g., blocks) of the method 200 illustrated in FIG. 9 and described below should not be taken as necessarily requiring a particular order or chronology of the method 200. Indeed, while the method 200 may be performed in the order of the steps (e.g., blocks) illustrated in FIG. 9 and described below, other orders or chronologies are also possible. Further, certain steps (e.g., blocks) of the method 200 illustrated in FIG. 9 and described below may be excluded in certain embodiments of the present disclosure, and certain steps (e.g., blocks) not illustrated in FIG. 9 and/or described below may be included in certain embodiments of the present disclosure.

In the illustrated embodiment, the method 200 includes disposing (block 202) battery componentry, such as an electrode assembly, one or more current collectors, one or more terminals (or portions thereof), an internal portion of a battery management unit (BMU), electrolyte, etc., within a battery enclosure having a longitudinal body section and a lateral body section. As previously described, the longitudinal body section and the lateral body section may intersect to define an interior corner of the battery enclosure. In some embodiments, the interior corner includes a curved and/or sloped surface. The longitudinal body section, the lateral body section, and the interior corner may form a generally L-shaped footprint (e.g., cross-sectional footprint) of the battery enclosure.

The method 200 also includes disposing (block 204) an external portion of the BMU of the battery along an exterior of the battery enclosure and adjacent to the interior corner. For example, the external portion of the BMU may include a chip board, a weld pad, a flex circuit, and/or an electrical feedthrough (or external portion thereof). The method 200 also includes electrically coupling (block 206) the external portion of the BMU with the battery componentry, such as an internal portion of the BMU, disposed in the interior of the battery enclosure. In some embodiments, the weld pad is employed to adhere the chip board to the exterior of the battery enclosure (e.g., the weld pad is positioned between and in contact with the chip board and the exterior of the battery enclosure), the flex circuit is employed to couple the chip board to an external portion of the electrical feedthrough, and the electrical feedthrough is employed to extend through an opening in the battery enclosure and into an interior of the battery enclosure. Other electrical connections may couple the electrical feedthrough to certain aspects of the battery componentry within the battery enclosure, such as one of the terminals or current collectors.

The method 200 also includes disposing (block 208) the battery in a battery area (e.g., battery receptacle, battery boundary) defined by a device enclosure such that the external portion of the BMU aligns with a portion of the battery area not receiving the battery enclosure. For example, as previously described, the battery area may include an additional longitudinal body section at least partially aligned with the longitudinal body section of the battery enclosure, an additional lateral body section at least partially aligned with the lateral body section of the battery enclosure, and an additional interior corner defined by an intersection between the additional longitudinal body section and the additional lateral body section. While the interior corner of the battery enclosure may include a curved and/or sloped surface, the additional interior corner of the battery area defined by the device enclosure may include some other shape characteristic, such as forming a right angle. For these reasons, among others, a portion of the battery area defined by the device enclosure may not receive the battery enclosure. Accordingly, the external portion of the BMU of the battery may be disposed along the exterior of the battery enclosure and adjacent to the interior corner of the battery enclosure such that, when the battery is disposed in the battery area defined by the device enclosure, the external portion of the BMU resides in the otherwise unused portion of the battery area.

In general, presently disclosed systems and methods improve spatial arrangements of battery componentry such that wasted space in a load (e.g., consumer electronic) employing the battery is reduced relative to traditional configurations and/or such that a capacity and/or volumetric energy density of the battery is improved relative to traditional configurations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery comprising:
an enclosure including a longitudinal body section and a lateral body section extending from and normal to the longitudinal body section, wherein an intersection of the longitudinal body section and the lateral body section defines an interior corner;
electrodes disposed within the enclosure; and
a battery management unit (BMU), wherein at least a portion of the BMU is disposed external to the enclosure and adjacent to the interior corner.

2. The battery of claim 1, wherein the portion of the BMU comprises a flex circuit, a weld pad, a chip board, an electrical feedthrough, or any combination thereof.

3. The battery of claim 1, wherein the portion of the BMU comprises a chip board.

4. The battery of claim 3, wherein the chip board is oriented such that a first thickness of the chip board extends transverse to a second thickness of the enclosure.

5. The battery of claim 3, wherein the chip board is oriented such that a first thickness of the chip board extends substantially parallel to a second thickness of the enclosure.

6. The battery of claim 1, wherein the interior corner comprises a curved surface along an exterior of the enclosure.

7. The battery of claim 1, wherein the portion of the BMU comprises a chip board and a weld pad, and the weld pad contacts the chip board and an exterior of the enclosure at the interior corner.

8. The battery of claim 1, comprising an electrical feedthrough establishing an electrical connection between the BMU and at least one electrode terminal tab corresponding to the electrodes, wherein the electrical feedthrough extends through an opening in the enclosure such that a first portion of the electrical feedthrough is disposed within the enclosure and a second portion of the electrical feedthrough is external to the enclosure.

9. The battery of claim 8, wherein the second portion of the electrical feedthrough is disposed adjacent to the interior corner.

10. The battery of claim 1, wherein the enclosure comprises:
an enclosure body having a flange; and
a cover that is seam welded to the flange of the enclosure body.

11. A battery comprising:
an enclosure including a first portion and a second portion extending transverse to the first portion, wherein an intersection of the first portion and the second portion defines an interior corner;
a plurality of electrodes forming a stacked arrangement within the enclosure; and
a battery management unit (BMU), wherein at least a portion of the BMU is disposed external to the enclosure and extends adjacent to the interior corner.

12. The battery of claim 11, wherein the portion of the BMU comprises a chip board or a flex circuit.

13. The battery of claim 11, wherein the portion of the BMU comprises a weld pad and a chip board, and the weld pad is coupled to the chip board and the interior corner.

14. The battery of claim 11, wherein the interior corner comprises a curved surface along an exterior of the enclosure.

15. The battery of claim 11, wherein the enclosure comprises a substantially L-shaped footprint formed by the first portion and the second portion.

16. A consumer electronic device comprising:
a device enclosure;
a boundary defined within the device enclosure;
a battery comprising a battery enclosure configured to be disposed within the boundary, wherein the battery enclosure comprises a first leg section and a second leg section extending from and normal to the first leg section such that an intersection between the first leg section and the second leg section defines an interior notch region;
a cavity adjacent to the interior notch region and between the battery enclosure and the boundary; and
a battery management unit (BMU) of the battery, wherein at least a portion of the BMU is disposed external to the battery enclosure and extends into the cavity.

17. The consumer electronic device of claim 16, wherein the interior notch region comprises a curved surface along an exterior of the battery enclosure.

18. The consumer electronic device of claim 16, wherein the portion of the BMU comprises a flex circuit, a weld pad, a chip board, an electrical feedthrough, or any combination thereof.

19. The consumer electronic device of claim 16, wherein the portion of the BMU comprises a chip board and a weld pad, and the weld pad is coupled to the chip board and an exterior of the battery enclosure adjacent to the interior notch region.

20. The consumer electronic device of claim 16, wherein the battery enclosure comprises a substantially L-shaped footprint formed by the first leg section and the second leg section.
